(19) United States
(12) Patent Application Publication
(10) Pub. No.: US 2020/0380158 A1
(43) Pub. Date: Dec. 3, 2020

(54) SYSTEMS AND METHODS FOR MANAGING DATA EXPECTATIONS

(71) Applicant: Pan Dimensional, Inc.

(72) Inventor: Brandon James Gillespie, Layton, UT (US)

(73) Assignee: Pan Dimensional, Inc.

(21) Appl. No.: 16/888,908

(22) Filed: Jun. 1, 2020

Related U.S. Application Data
(60) Provisional application No. 62/854,928, filed on May 30, 2019.

(51) Int. Cl. G06F 21/62; G06F 16/245

(52) U.S. Cl. CPC G06F 21/6227; G06F 16/245

(57) ABSTRACT

Systems and methods for executing a containerized computer code from a remote are disclosed. A controller module receives the request and applies data expectation rules to the request. The request must meet the requirements of the data expectation rules before the controller module will execute the containerized computer code. The controller module is configured to access data not necessarily accessible by the requesting application for use with executing the containerized computer code.

### CROSS-REFERENCE TO RELATED APPLICATIONS

This application claims priority to U.S. Provisional Patent Application No. 62/854,928 filed on May 30, 2019 entitled DATA UNIVERSE which is incorporated herein by reference in its entirety.

### BACKGROUND

Today's economy and social life is increasingly carried out with various types of computing systems including servers, personal computers, smartphones, and the vast number of smart objects in our infrastructure and environment known as the “internet of things.” These components operate together by exchanging data, but this data is difficult to secure and exchange with safety. Establishing trust between computing devices allows for the free flow of information and for the many aspects of modern life to go on all around us, but even managing that trust is a challenge, as data is difficult to secure when too many parties are involved. Without a better way to provide safe access to data, these important aspects of our economic and social lives cannot operate. There is a need in the art for a way to establish trust between computing systems so information can be exchanged, components can run small programs with access to data, without having to have full trust granted, allowing for their objectives to be carried out.

### SUMMARY

Embodiments of the present disclosure are directed to a system for executing a containerized computer code. The system includes a data expectations controller module that itself includes an input data expectation module configured to receive a query input from an application. The application submits the query input as a request for the containerized computer code to generate an output data. The data expectations controller module also includes a data expectations rules module that executes several routines: a receive data routine comprising communicating with a remote data source to receive information from the remote data source; a pull data routine comprising initiating a request to the remote data source regarding the query input; a push data routine comprising sending information to the remote data source; a modify data routine comprising shaping or altering data received from one or more of the query input, the receive data routine, and the pull data routine; and a match data routine comprising comparing parameters in the query input to a set of data expectation parameters based on the query input, wherein the match data routine requires a certain predetermined level of match between the parameters in the query input to the data expectation parameters to execute the containerized computer code. The remote data source comprises one or more remote data sources that are not in communication with or under the control of the application. The data expectations rules module is configured to submit the query input to the containerized computer code if the data expectations rules module determined that sufficient parameters have been met, otherwise the data expectations rules module will return an error. The data expectations controller module does not allow communication of data between the remote data source and the application. The data expectations controller module is further configured to deliver results of the containerized computer code to the application.

Further embodiments of the present disclosure are directed to a computer-implemented method for receiving a request to execute containerized computer code. The method is a way of improving the way computers work as tools. The method includes receiving at a controller module a query input from an external application that includes input data for the containerized computer code. The method also includes implementing data expectation rules on the input query. The data expectation rules comprise identifying a secondary data source related to the input query (the application does not have knowledge of the secondary data source), pulling secondary data from the secondary data source, modifying the input query using the secondary data to form a composite data input for the containerized computer code, shaping the composite data input according to the containerized computer code, and matching the query input against predetermined expectations required for the containerized computer code to run. The method also includes returning an error if the query input does not match the predetermined expectations required for the containerized computer code to run, and executing the containerized computer code if the query input does match the predetermined expectations required for the containerized computer code to run, wherein the containerized computer code generates an output. The method also includes shaping the output of the containerized computer code into a shaped output, and returning the shaped output to the application. The controller module does not share information between the application and the secondary data source.

### BRIEF DESCRIPTION OF THE FIGURES

FIG. 1 is a schematic diagram of a system for managing, executing, and controlling access to data according to embodiments of the present disclosure.

FIG. 2 is a flowchart diagram showing a method of implementation of a controller upon receiving a request from an application according to embodiments of the present disclosure.

FIG. 3 is a block diagram of an exemplary computing system capable of implementing one or more of the embodiments described and/or illustrated herein.

FIG. 4 is a block diagram of an exemplary computing network capable of implementing one or more of the embodiments described herein.

### DETAILED DESCRIPTION

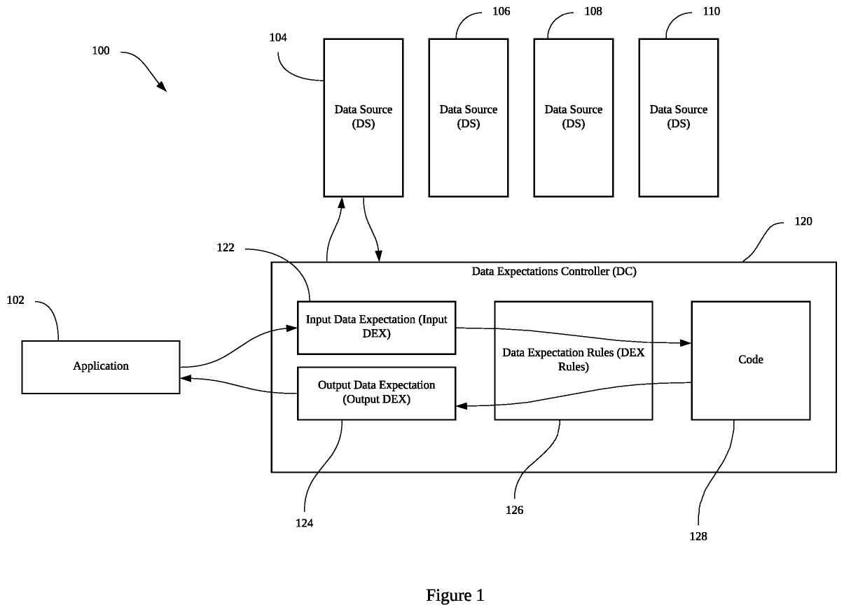

Below is a detailed description according to various embodiments of the present disclosure. FIG. 1 is a schematic diagram of a system 100 for managing, executing, and controlling access to data according to embodiments of the present disclosure.

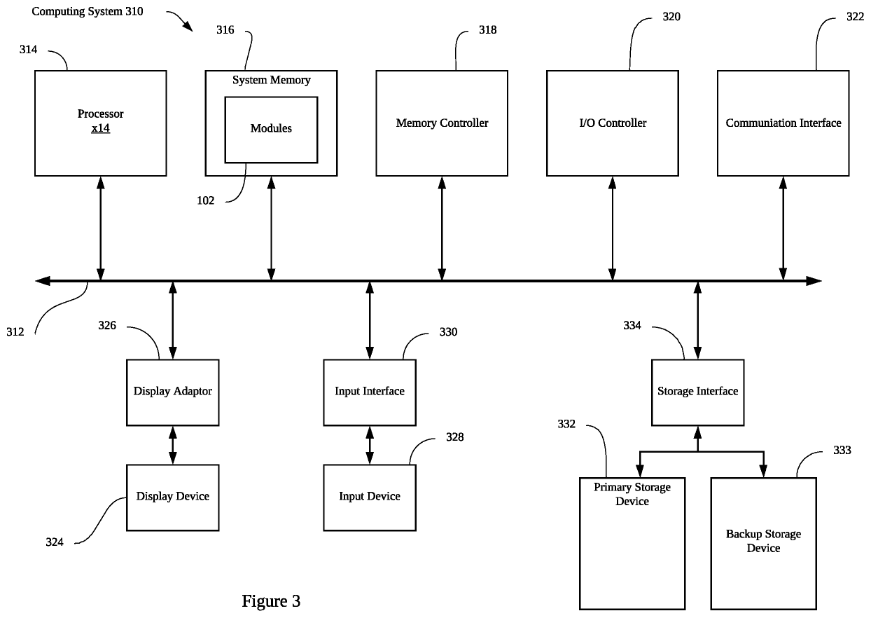

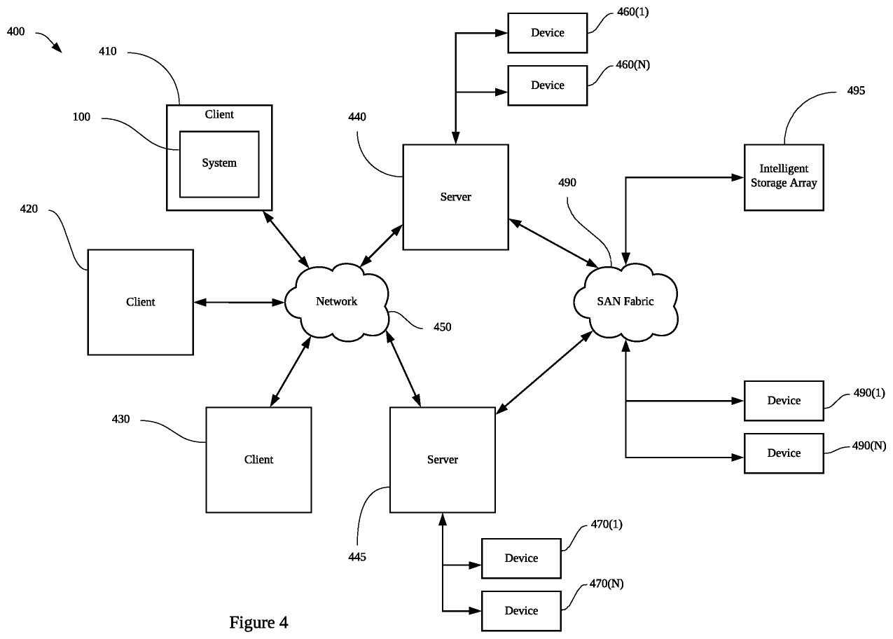

In certain embodiments, one or more of the components of FIG. 1 may represent one or more software applications or programs that, when executed by a computing device, may cause the computing device to perform one or more tasks. For example, and as will be described in greater detail below, one or more of components may represent software modules stored and configured to run on one or more computing devices, such as the devices illustrated in FIGS. 3 and 4 below.

The system 100 includes an application 102 that can be any software, website, corporation, legal entity, or any other suitable entity that wishes to access data for any purpose. The application 102 is broadly defined and can be virtually any object capable of executing computer code in any capacity whatsoever. It will become clear throughout the disclosure that aspects of the present disclosure can be applied in virtually any context in which an application wishes to exchange data or execute code using data from a remote source. In embodiments a data expectations controller 120 (also referred to herein as a controller 120) operates a series of rules for data operations, data management, and data control in a manner that facilitates code execution on data and maintainability of such data. The application 102 can be referred to as an application module and the controller 120 can be referred to as a controller module. These and other modules can be stored in a computer memory and executed by a processor as is shown in greater detail below in FIGS. 3 and 4.

The controller 120 acts as a gatekeeper for the data that is being requested by the application 102. The controller 120 can also apply data shaping to ensure that the shape of the data being delivered is appropriate for the request. The controller 120 can also use data shaping as a security measure by allowing function calls only when the data shape is appropriate. The controller 120 can also augment data in a deterministic (human created rules) heuristic and/or stochastic (Al selected) probabilistic way to obtain data not directly requested by the application, but that is known by the controller 120 to be appropriate for, required by, or at least related to the request.

The controller 120 interfaces with data sources 104, 106, 108, and 110. There can be any number of data sources, but for purposes of simplicity and brevity, the operation of the system 100 will be described in terms of an interface with a single data source 104. The data sources can be broadly defined as any database, API, or any other computing entity capable of storing data and communicating that data. Smartphones, computers, servers, and embedded processors are just a few examples of data sources.

The application 102 sends a request to the controller 120 which may include a request for data, and may also include some data as part of the request. The data expectations controller 120 receives the request, applies rules as will be described herein in greater detail, and interfaces with the data source or sources, which may include data sources not considered by the application 102 or that the application 102 may consider relevant to the request. The controller 120 can return data back to the application 102 to complete the transaction.

The data expectations controller 120 can use code 128 that is the function that the application 102 desires to run on the data. The code 128 is a containerized application, which is a way of packaging software including the code and necessary dependencies to run the application, such as runtime, system tools, system libraries, and settings. This containerized application is then able to run quickly and reliably from one computing environment to another, where the software is isolated from its environment to ensure that it works uniformly despite differences between environments. An example of using containers is Docker, but other methods of containerization may apply, including any system that packages, distributes and runs software in a uniform manner such as this.

In some embodiments the controller 120 applies Input Data Expectations 122, Data Expectation Rules 126, and provides an Output Data Expectations 124. In an example, the application 102 submits a request to the controller 120. The controller 120 applies Input Data Expectations 122 to the request, applies Data Expectation Rules 126, runs the code 128, applies Output Data Expectations 124, and returns data to the application. At any time during this process the controller 120 can interact with the data source 104.

The controller 120 can execute one or more of the following operations on the data as it processes the request from the application 102:

1. Receive Data;

2. Pull Data;

3. Push Data;

4. Modify Data; and

5. Match Data;

Receive. Data can be sent from the application 102 to the controller 120 via any suitable electronic communication method such as over the internet. Receiving data can also include receiving data that is external from the application 102. In some cases receiving the data can include receiving data from the data source 104. In other embodiments receiving the data includes receiving data from one or more data sources 106, 108, or 110. In some embodiments the data source from which the data is received by the controller 120 is not known to the application 102. In some embodiments the link between the request issued by the application 102 and the data source from which the controller 120 receives the data is known to the controller and not to the application 102.

Pull. Pull is executed by the controller 120 to obtain data from one or more of the data sources. Pull is similar to receive, but in Pull the controller 120 initiates the transfer of data. The Pull itself and/or the source from which the data is pulled may be known to the controller 120 and not the application 102, or it can be known by the application 102 as well as the controller 120. The controller 120 can store rules for the Pull which dictate what data is to be pulled and from which source, based on aspects of the request from the application 102. For example, if the application is a credit card company and the request pertains to creditworthiness of an individual, the data sources may be the individual, the individual's financial institutions, etc. An example of a Pull to a source not known to the application 102 is if the controller 120 knows of a financial relationship the individual has that has some relevance to the application's request, the controller 120 can initiate data communication about that relationship, even though the relationship may not be accessible to the application 102, or it may be unknown by the application 102.

Push. Push includes storing data after the code 128 runs and produces information. The information can be stored on the controller 120 and may also be provided to the application 102 or to one or more of the data sources.

Modify. Modify is a process by which data is shaped or altered either before or after the code 128 is run on the data. In some embodiments data shaping means formatting and/or organizing data in a required way. Modify can also include enrichment of data by adding data that is pulled from other sources (using a Pull) or by using data locally stored or from any other suitable source. The controller 120 can enrich data received from the application 102 to improve or alter the operation of the code 128 on the data. Enriching data can include adding secondary data pulled from secondary sources that may or may not be known to the application 102. The secondary data can be injected into the input data, and the secondary data is subject to the same access controls as the primary data for the code 128. The controller 120 can incorporate the primary and secondary data together before running the code 128 on the combined data, or it can run a separate module for the secondary data.

Match. Match is a process that acts as a firewall to prevent unauthorized uses of the code 128. The rules 126 can contain a set of expectations for the code 128 and the incoming data sent by the application 102 intended to be run by the code 128. If the data sent by the application 102 is not properly shaped according to the expectations, or all of the expectations are not met, the code 128 will not run. The expectations describe what data elements and content are allowed into or out of the code 128. Attributes and their criteria which need to be met for the code 128 to run may include matching against the gathered data and purpose, time, location, or other attribute-based access controls or dimensions.

In some embodiments the controller 120 is equipped to perform a Receive, Pull, Push, Modify, and Match execution for each request issued by the application 102.

In some embodiments of the present disclosure the code 128 is a containerized application that is an industry standard containerized application according to well-known standards such as Docker. In addition to these standard definitions, the DEX rules 126 are applied either before or after the code 128 runs. In the case of prior application, the controller 120 handles the DEX rules 126 first, before the code 128 can even run. In some embodiments the requirements are strict. For example, the data must have the exact shape required by the DEX rules 126, and if they are not met the controller 120 does not call the code 128 at all. In the case of post application, the DEX rules 126 can modify, augment, enrich or otherwise change the data accordingly before returning any result of the code's operation.

In other words, the controller 120 uses the DEX rules 126 as a firewall around the code 128. The operations of the DEX rules 126 also allow the application 102 to run code 128 without needing all the information required to run the code 128. In many cases the inputs for the code 128 to run are not shown to the application 102. For example, suppose the application 102 is a request for a credit score for an individual. The application 102 may have authority to request the credit score, but it does not have sufficient security authorization to see all the data required to arrive at the credit score, such as past employment history, transaction history, bank account values, etc. The controller 120 thereby protects access to the data source 104 while still allowing the application 102 to receive the results of its request.

Also in some embodiments the code 128 does not have access to the data sources. The controller 120 therefore acts as an arbitrator of data access between the application 102 and the data source 104.

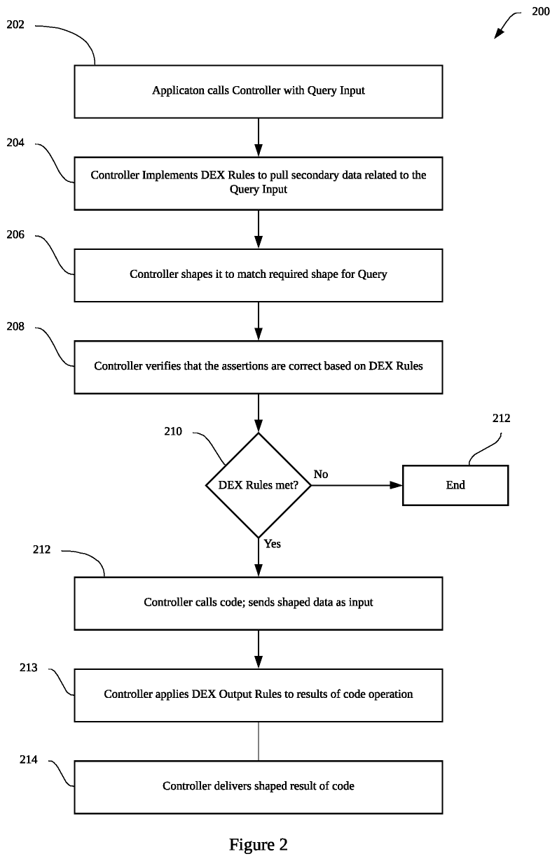

FIG. 2 is a flowchart diagram showing a method 200 of implementation of a controller upon receiving a request from an application according to embodiments of the present disclosure. The application, controller, data sources, and code referenced in FIG. 2 are the same as in FIG. 1. At 202 the application calls the controller with a Query Input. The query input can be any sort of information necessary for the request to execute, and will depend on the needs of the application at any given time. In an example the application is requesting a credit score for an individual. The Query Input can be the user's unique id, and may also include other initial data such as name, social security, phone number, or other information. At 204 the controller implements the DEX Rules to pull secondary data related to the Query Input. The controller is configured to identify which secondary data should be pulled and from where it should be pulled. This link is maintained by the controller and is not shared with the application. In some embodiments it is not shared with the containerized code either.

At 206 the controller shapes the data to match the requirements of the code. At 208 the controller verifies that all assertions are correct. For example, the controller can verify that the application in fact has access to the information it is purporting. In the case of the credit score, the Query Input may include an assertion that the application is authorized to access the credit score. The controller can verify this before proceeding. In another embodiment the DEX Rules can include attributes that are out of the control of the application. The controller use external sources to verify the application is running from the authorized bank, including IP addresses or other geolocation identifiers.

At 210 the controller can check to be sure that all DEX Rules are met, including the shape of the data, the intention of the data, etc. If not, at 212 the process ends. If they are met, at 212 the controller calls the code and sends the shaped data as input to the code. At 213 the controller can apply DEX Rules in an output orientation to the results of the code operation. The DEX Output rules can be similar to how the DEX Rules are applied before reaching the code, and can be done in reverse. The data that results from running the code can be subject to the shaping and other DEX rules that are applied before running the code. At 214 the controller delivers the shaped result of the code. In some embodiments the controller can shape the data after the code runs.

FIG. 3 is a block diagram of an exemplary computing system 310 capable of implementing one or more of the embodiments described and/or illustrated herein. For example, all or a portion of computing system 310 may perform and/or be a means for performing, either alone or in combination with other elements, one or more of the steps described herein (such as one or more of the steps illustrated in FIG. 3). All or a portion of computing system 310 may also perform and/or be a means for performing any other steps, methods, or processes described and/or illustrated herein.

Computing system 310 broadly represents any single or multi-processor computing device or system capable of executing computer-readable instructions. Examples of computing system 310 include, without limitation, workstations, laptops, client-side terminals, servers, distributed computing systems, handheld devices, or any other computing system or device. In its most basic configuration, computing system 310 may include at least one processor 314 and a system memory 316.

Processor 314 generally represents any type or form of physical processing unit (e.g., a hardware-implemented central processing unit) capable of processing data or interpreting and executing instructions. In certain embodiments, processor 314 may receive instructions from a software application or module. These instructions may cause processor 314 to perform the functions of one or more of the exemplary embodiments described and/or illustrated herein.

System memory 316 generally represents any type or form of volatile or non-volatile storage device or medium capable of storing data and/or other computer-readable instructions. Examples of system memory 316 include, without limitation, Random Access Memory (RAM), Read Only Memory (ROM), flash memory, or any other suitable memory device. Although not required, in certain embodiments computing system 310 may include both a volatile memory unit (such as, for example, system memory 316) and a non-volatile storage device (such as, for example, primary storage device 332, as described in detail below). In one example, one or more of modules 102 from FIG. 1 may be loaded into system memory 316.

In certain embodiments, exemplary computing system 310 may also include one or more components or elements in addition to processor 314 and system memory 316. For example, as illustrated in FIG. 3, computing system 310 may include a memory controller 318, an Input/Output (I/O) controller 320, and a communication interface 322, each of which may be interconnected via a communication infrastructure 312. Communication infrastructure 312 generally represents any type or form of infrastructure capable of facilitating communication between one or more components of a computing device. Examples of communication infrastructure 312 include, without limitation, a communication bus (such as an Industry Standard Architecture (ISA), Peripheral Component Interconnect (PCI), PCI Express (PCIe), or similar bus) and a network.

Memory controller 318 generally represents any type or form of device capable of handling memory or data or controlling communication between one or more components of computing system 310. For example, in certain embodiments memory controller 318 may control communication between processor 314, system memory 316, and I/O controller 320 via communication infrastructure 312.

I/O controller 320 generally represents any type or form of module capable of coordinating and/or controlling the input and output functions of a computing device. For example, in certain embodiments I/O controller 320 may control or facilitate transfer of data between one or more elements of computing system 310, such as processor 314, system memory 316, communication interface 322, display adapter 326, input interface 330, and storage interface 334.

Communication interface 322 broadly represents any type or form of communication device or adapter capable of facilitating communication between exemplary computing system 310 and one or more additional devices. For example, in certain embodiments communication interface 322 may facilitate communication between computing system 310 and a private or public network including additional computing systems. Examples of communication interface 322 include, without limitation, a wired network interface (such as a network interface card), a wireless network interface (such as a wireless network interface card), a modem, and any other suitable interface. In at least one embodiment, communication interface 322 may provide a direct connection to a remote server via a direct link to a network, such as the Internet. Communication interface 322 may also indirectly provide such a connection through, for example, a local area network (such as an Ethernet network), a personal area network, a telephone or cable network, a cellular telephone connection, a satellite data connection, or any other suitable connection.

In certain embodiments, communication interface 322 may also represent a host adapter configured to facilitate communication between computing system 310 and one or more additional network or storage devices via an external bus or communications channel. Examples of host adapters include, without limitation, Small Computer System Interface (SCSI) host adapters, Universal Serial Bus (USB) host adapters, Institute of Electrical and Electronics Engineers (IEEE) 1394 host adapters, Advanced Technology Attachment (ATA), Parallel ATA (PATA), Serial ATA (SATA), and External SATA (eSATA) host adapters, Fibre Channel interface adapters, Ethernet adapters, or the like. Communication interface 322 may also allow computing system 310 to engage in distributed or remote computing. For example, communication interface 322 may receive instructions from a remote device or send instructions to a remote device for execution.

As illustrated in FIG. 3, computing system 310 may also include at least one display device 324 coupled to communication infrastructure 312 via a display adapter 326. Display device 324 generally represents any type or form of device capable of visually displaying information forwarded by display adapter 326. Similarly, display adapter 326 generally represents any type or form of device configured to forward graphics, text, and other data from communication infrastructure 312 (or from a frame buffer, as known in the art) for display on display device 324.

As illustrated in FIG. 3, exemplary computing system 310 may also include at least one input device 328 coupled to communication infrastructure 312 via an input interface 330. Input device 328 generally represents any type or form of input device capable of providing input, either computer or human generated, to exemplary computing system 310. Examples of input device 328 include, without limitation, a keyboard, a pointing device, a speech recognition device, or any other input device.

As illustrated in FIG. 3, exemplary computing system 310 may also include a primary storage device 332 and a backup storage device 333 coupled to communication infrastructure 312 via a storage interface 334. Storage devices 332 and 333 generally represent any type or form of storage device or medium capable of storing data and/or other computer-readable instructions. For example, storage devices 332 and 333 may be a magnetic disk drive (e.g., a so-called hard drive), a solid state drive, a floppy disk drive, a magnetic tape drive, an optical disk drive, a flash drive, or the like. Storage interface 334 generally represents any type or form of interface or device for transferring data between storage devices 332 and 333 and other components of computing system 310. In one example, global metadata repository 120 from FIG. 1 may be stored in primary storage device 332.

In certain embodiments, storage devices 332 and 333 may be configured to read from and/or write to a removable storage unit configured to store computer software, data, or other computer-readable information. Examples of suitable removable storage units include, without limitation, a floppy disk, a magnetic tape, an optical disk, a flash memory device, or the like. Storage devices 332 and 333 may also include other similar structures or devices for allowing computer software, data, or other computer-readable instructions to be loaded into computing system 310. For example, storage devices 332 and 333 may be configured to read and write software, data, or other computer-readable information. Storage devices 332 and 333 may also be a part of computing system 310 or may be a separate device accessed through other interface systems.

Many other devices or subsystems may be connected to computing system 310. Conversely, all of the components and devices illustrated in FIG. 3 need not be present to practice the embodiments described and/or illustrated herein. The devices and subsystems referenced above may also be interconnected in different ways from that shown in FIG. 3. Computing system 310 may also employ any number of software, firmware, and/or hardware configurations. For example, one or more of the exemplary embodiments disclosed herein may be encoded as a computer program (also referred to as computer software, software applications, computer-readable instructions, or computer control logic) on a computer-readable medium. The term “computer-readable medium,” as used herein, generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The computer-readable medium containing the computer program may be loaded into computing system 310. All or a portion of the computer program stored on the computer-readable medium may then be stored in system memory 316 and/or various portions of storage devices 332 and 333. When executed by processor 314, a computer program loaded into computing system 310 may cause processor 314 to perform and/or be a means for performing the functions of one or more of the exemplary embodiments described and/or illustrated herein. Additionally or alternatively, one or more of the exemplary embodiments described and/or illustrated herein may be implemented in firmware and/or hardware. For example, computing system 310 may be configured as an Application Specific Integrated Circuit (ASIC) adapted to implement one or more of the exemplary embodiments disclosed herein.

FIG. 4 is a block diagram of an exemplary network architecture 400 in which client systems 410, 420, and 430 and servers 440 and 445 may be coupled to a network 450. As detailed above, all or a portion of network architecture 400 may perform and/or be a means for performing, either alone or in combination with other elements, one or more of the steps disclosed herein (such as one or more of the steps illustrated in FIG. 3). All or a portion of network architecture 400 may also be used to perform and/or be a means for performing other steps and features set forth in the instant disclosure.

Client systems 410, 420, and 430 generally represent any type or form of computing device or system, such as exemplary computing system 310 in FIG. 3. Similarly, servers 440 and 445 generally represent computing devices or systems, such as application servers or database servers, configured to provide various database services and/or run certain software applications. Network 450 generally represents any telecommunication or computer network including, for example, an intranet, a WAN, a LAN, a PAN, or the Internet. In one example, client systems 410, 420, and/or 430 and/or servers 440 and/or 445 may include all or a portion of system 100 from FIG. 1.

As illustrated in FIG. 4, one or more storage devices 460(1)-(N) may be directly attached to server 440. Similarly, one or more storage devices 470(1)-(N) may be directly attached to server 445. Storage devices 460(1)-(N) and storage devices 470(1)-(N) generally represent any type or form of storage device or medium capable of storing data and/or other computer-readable instructions. In certain embodiments, storage devices 460(1)-(N) and storage devices 470(1)-(N) may represent Network-Attached Storage (NAS) devices configured to communicate with servers 440 and 445 using various protocols, such as Network File System (NFS), Server Message Block (SMB), or Common Internet File System (CIFS).

Servers 440 and 445 may also be connected to a Storage Area Network (SAN) fabric 480. SAN fabric 480 generally represents any type or form of computer network or architecture capable of facilitating communication between a plurality of storage devices. SAN fabric 480 may facilitate communication between servers 440 and 445 and a plurality of storage devices 490(1)-(N) and/or an intelligent storage array 495. SAN fabric 480 may also facilitate, via network 450 and servers 440 and 445, communication between client systems 410, 420, and 430 and storage devices 490(1)-(N) and/or intelligent storage array 495 in such a manner that devices 490(1)-(N) and array 495 appear as locally attached devices to client systems 410, 420, and 430. As with storage devices 460(1)-(N) and storage devices 470(1)-(N), storage devices 490(1)-(N) and intelligent storage array 495 generally represent any type or form of storage device or medium capable of storing data and/or other computer-readable instructions.

In certain embodiments, and with reference to exemplary computing system 310 of FIG. 3, a communication interface, such as communication interface 322 in FIG. 3, may be used to provide connectivity between each client system 410, 420, and 430 and network 450. Client systems 410, 420, and 430 may be able to access information on server 440 or 445 using, for example, a web browser or other client software. Such software may allow client systems 410, 420, and 430 to access data hosted by server 440, server 445, storage devices 460(1)-(N), storage devices 470(1)-(N), storage devices 490(1)-(N), or intelligent storage array 495. Although FIG. 4 depicts the use of a network (such as the Internet) for exchanging data, the embodiments described and/or illustrated herein are not limited to the Internet or any particular network-based environment.

In at least one embodiment, all or a portion of one or more of the exemplary embodiments disclosed herein may be encoded as a computer program and loaded onto and executed by server 440, server 445, storage devices 460(1)-(N), storage devices 470(1)-(N), storage devices 490(1)-(N), intelligent storage array 495, or any combination thereof. All or a portion of one or more of the exemplary embodiments disclosed herein may also be encoded as a computer program, stored in server 440, run by server 445, and distributed to client systems 410, 420, and 430 over network 450.

As detailed above, computing system 310 and/or one or more components of network architecture 400 may perform and/or be a means for performing, either alone or in combination with other elements, one or more steps of an exemplary method for utilizing information-asset metadata aggregated from multiple disparate data-management systems.

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered exemplary in nature since many other architectures can be implemented to achieve the same functionality.

In some examples, all or a portion of exemplary system 100 in FIG. 1 may represent portions of a cloud-computing or network-based environment. Cloud-computing environments may provide various services and applications via the Internet. These cloud-based services (e.g., software as a service, platform as a service, infrastructure as a service, etc.) may be accessible through a web browser or other remote interface. Various functions described herein may be provided through a remote desktop environment or any other cloud-based computing environment.

In various embodiments, all or a portion of exemplary system 100 in FIG. 1 may facilitate multi-tenancy within a cloud-based computing environment. In other words, the software modules described herein may configure a computing system (e.g., a server) to facilitate multi-tenancy for one or more of the functions described herein. For example, one or more of the software modules described herein may program a server to enable two or more clients (e.g., customers) to share an application that is running on the server. A server programmed in this manner may share an application, operating system, processing system, and/or storage system among multiple customers (i.e., tenants). One or more of the modules described herein may also partition data and/or configuration information of a multi-tenant application for each customer such that one customer cannot access data and/or configuration information of another customer.

According to various embodiments, all or a portion of exemplary system 100 in FIG. 1 may be implemented within a virtual environment. For example, the modules and/or data described herein may reside and/or execute within a virtual machine. As used herein, the term “virtual machine” generally refers to any operating system environment that is abstracted from computing hardware by a virtual machine manager (e.g., a hypervisor). Additionally or alternatively, the modules and/or data described herein may reside and/or execute within a virtualization layer. As used herein, the term “virtualization layer” generally refers to any data layer and/or application layer that overlays and/or is abstracted from an operating system environment. A virtualization layer may be managed by a software virtualization solution (e.g., a file system filter) that presents the virtualization layer as though it were part of an underlying base operating system. For example, a software virtualization solution may redirect calls that are initially directed to locations within a base file system and/or registry to locations within a virtualization layer.

In some examples, all or a portion of exemplary system 100 in FIG. 1 may represent portions of a mobile computing environment. Mobile computing environments may be implemented by a wide range of mobile computing devices, including mobile phones, tablet computers, e-book readers, personal digital assistants, wearable computing devices (e.g., computing devices with a head-mounted display, smartwatches, etc.), and the like. In some examples, mobile computing environments may have one or more distinct features, including, for example, reliance on battery power, presenting only one foreground application at any given time, remote management features, touchscreen features, location and movement data (e.g., provided by Global Positioning Systems, gyroscopes, accelerometers, etc.), restricted platforms that restrict modifications to system-level configurations and/or that limit the ability of third-party software to inspect the behavior of other applications, controls to restrict the installation of applications (e.g., to only originate from approved application stores), etc. Various functions described herein may be provided for a mobile computing environment and/or may interact with a mobile computing environment.

In addition, all or a portion of exemplary system 100 in FIG. 1 may represent portions of, interact with, consume data produced by, and/or produce data consumed by one or more systems for information management. As used herein, the term “information management” may refer to the protection, organization, and/or storage of data. Examples of systems for information management may include, without limitation, storage systems, backup systems, archival systems, replication systems, high availability systems, data search systems, virtualization systems, and the like.

In some embodiments, all or a portion of exemplary system 100 in FIG. 1 may represent portions of, produce data protected by, and/or communicate with one or more systems for information security. As used herein, the term “information security” may refer to the control of access to protected data. Examples of systems for information security may include, without limitation, systems providing managed security services, data loss prevention systems, identity authentication systems, access control systems, encryption systems, policy compliance systems, intrusion detection and prevention systems, electronic discovery systems, and the like.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the instant disclosure. The embodiments disclosed herein should be considered in all respects illustrative and not restrictive. Reference should be made to the appended claims and their equivalents in determining the scope of the instant disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

The foregoing disclosure hereby enables a person of ordinary skill in the art to make and use the disclosed systems without undue experimentation. Certain examples are given to for purposes of explanation and are not given in a limiting manner.

1. A system for executing a containerized computer code, comprising:
a data expectations controller module, comprising:
an input data expectation module configured to receive a query input from an application, wherein the application submits the query input as a request for the containerized computer code to generate an output data;
a data expectations rules module configured to execute:
a receive data routine comprising communicating with a remote data source to receive information from the remote data source;
a pull data routine comprising initiating a request to the remote data source regarding the query input;
a push data routine comprising sending information to the remote data source;
a modify data routine comprising shaping or altering data received from one or more of the query input, the receive data routine, and the pull data routine;
a match data routine comprising comparing parameters in the query input to a set of data expectation parameters based on the query input, wherein the match data routine requires a certain predetermined level of match between the parameters in the query input to the data expectation parameters to execute the containerized computer code;
wherein the remote data source comprises one or more remote data sources that are not in communication with or under the control of the application; and
wherein the data expectations rules module is configured to submit the query input to the containerized computer code if the data expectations rules module determined that sufficient parameters have been met, otherwise the data expectations rules module will return an error; and
wherein the data expectations controller module does not allow communication of data between the remote data source and the application; and
wherein the data expectations controller module is further configured to deliver results of the containerized computer code to the application.

2. The system of claim 1 wherein the data expectations rule module is further configured to shape the query input before submitting the query input to the containerized code.

3. The system of claim 1 wherein the data expectations rules module is further configured to execute a post-shaping routine in which data received from the containerized computer code is shaped according to rules in the data expectations rules module.

4. The system of claim 1 wherein the data expectations rules module is further configured to store the parameters against which the data expectations rules module is configured to judge sufficiency of a match.

5. The system of claim 1 wherein the application is prevented from communicating with the remote data sources by the data expectations controller module.

6. The system of claim 1 wherein the data expectations rules module is further configured to store a link between a set of input queries and remote data sources.

7. The system of claim 1 wherein the modify data routine further comprises an enriching data routine whereby additional data is obtained to enhance the containerized computer code.

8. The system of claim 1 wherein the results of the containerized computer code comprises information derived by the system from a remote data source to which the application does not have direct access.

9. A computer-implemented method for receiving a request to execute containerized computer code, the method being performed by a computing device comprising at least one processor, the method comprising:
receiving at a controller module a query input from an external application, wherein the query input includes input data for the containerized computer code;
implementing data expectation rules on the input query, wherein the data expectation rules comprise:
identifying a secondary data source related to the input query, wherein the application does not have knowledge of the secondary data source;
pulling secondary data from the secondary data source;
modifying the input query using the secondary data to form a composite data input for the containerized computer code;
shaping the composite data input according to the containerized computer code;
matching the query input against predetermined expectations required for the containerized computer code to run;
returning an error if the query input does not match the predetermined expectations required for the containerized computer code to run;
executing the containerized computer code if the query input does match the predetermined expectations required for the containerized computer code to run, wherein the containerized computer code generates an output;
shaping the output of the containerized computer code into a shaped output; and
returning the shaped output to the application;
wherein the controller module does not share information between the application and the secondary data source.

10. The method of claim 9 wherein receiving at the controller module the query input from the external application comprises receiving a request for a result of the containerized computer code that is derived from information to which the application does not have direct access.

11. The method of claim 9, further comprising maintaining a link between input queries received from the application to associated secondary data sources, and wherein the link is not shared by the controller module to the application.

12. The method of claim 9, further comprising preventing sharing information between the secondary data source and the application.

13. The method of claim 9, further comprising receiving assertions with the input query, and checking the assertions before executing the containerized computer code.
